(19) United States
(12) Patent Application Publication
(10) Pub. No.: US 2004/0047326 A1
(43) Pub. Date: Mar. 11, 2004

(54) Employment of one traffic block of one code division multiple access traffic channel to communicate respective portions of communications between communication components

(76) Inventor: Tienyu Chiu, Naperville, IL (US)

Correspondence Address: PATTI & BRILL, ONE NORTH LASALLE STREET, 44TH FLOOR, CHICAGO, IL, 60602, US

(21) Appl. No.: 10/235,582

(22) Filed: Sep. 5, 2002

(51) Int. Cl. H04B 7/216

(52) U.S. Cl. 370/342

(57) ABSTRACT

An apparatus in one example comprises a first communication component that employs one traffic block of one code division multiple access traffic channel to communicate respective portions of first and second communications to a second communication component.

### TECHNICAL FIELD

The invention relates generally to communications and more particularly to wireless traffic channel communication.

### BACKGROUND

One configuration of a wireless communications device allows a person to carry on a voice conversation with another person at a given time. At another time, the person can employ the wireless communications device to send and/or receive data. In one example of data communication, the person employs the wireless communications device to exchange information with the other person. In another example of data communication, the person employs the wireless communications device to access a website on the internet.

As one shortcoming, the person cannot employ the wireless communications device to conduct an ongoing voice conversation at the same time that the person employs the wireless communications device to communicate data. At the time that the person engages in the voice conversation, the wireless communications device is unavailable for data communication. As one disadvantage, the person must therefore terminate the voice conversation before employing that wireless communications device to perform data communication. Likewise, at a time that the person employs the wireless communications device for data communication, the wireless communications device cannot support a voice conversation. So, the person disadvantageously must end the data communication before employing the wireless communications device to engage in the voice conversation.

Exemplary technologies for support of wireless communication include code division multiple access (“CDMA”) and time division multiple access (“TDMA”). One system employing code division multiple access undesirably requires use of two active channels for support of an ongoing voice conversation at the same time that the system supports data communication. The first active channel of code division multiple access technology serves to carry the voice conversation. The second active channel of code division multiple access technology serves to carry the data communication.

One system employing time division multiple access technology disadvantageously requires use of two timeslots for support of continuing voice conversation at the same time that the system supports data communication. The first timeslot of time division multiple access technology serves to carry the voice conversation. The second timeslot of time division multiple access technology serves to carry the data communication.

As one shortcoming, such systems employing code division multiple access or time division multiple access technologies disadvantageously require multiple resources to support concurrent voice and data needs of one user. As another shortcoming, the systems are unable to support as many needs for as many users as would be the case were the multiple resources not so required, since the systems have a limit on the number of resources that are available to support possible users and needs.

Thus, a need exists for enhanced employment of a traffic channel for support of wireless communication. A need also exists for enhanced employment of multiple traffic channels to support wireless communications of a plurality of users. A further need exists for enhanced employment of a traffic channel for support of multiple types of wireless communications. Another need exists for enhanced employment of a wireless traffic channel to support ongoing voice conversation concurrently with data communication.

### SUMMARY

The invention in one embodiment encompasses an apparatus. The apparatus includes a first communication component that employs one traffic block of one code division multiple access traffic channel to communicate respective portions of first and second communications to a second communication component.

Another embodiment of the invention encompasses an apparatus. The apparatus includes a first communication component that communicates with a second communication component: a first subportion of a first communication in a first traffic block of one code division multiple access traffic channel, a portion of a second communication in a second traffic block of the one code division multiple access traffic channel, and a second subportion of the first communication in a third traffic block of the one code division multiple access traffic channel. The second traffic block is subsequent to the first traffic block. The third traffic block is subsequent to the second traffic block.

Yet another embodiment of the invention encompasses an apparatus. The apparatus includes a first communication component that inserts identifier information into an identifier portion of a message to indicate a division of a traffic portion of the message into traffic subportions that comprise first and second traffic subportions. The first communication component communicates respective portions of first and second communications in the first and second traffic subportions, respectively, over a wireless traffic channel to a second communication component.

A further embodiment of the invention encompasses a method. A traffic portion of a message is divided into traffic subportions that comprise first and second traffic subportions. Respective portions of first and second communications are inserted into the first and second traffic subportions, respectively. Identifier information is inserted into an identifier portion of the message. The identifier portion comprises a description of the portions of the first and second communications. The message is communicated over a wireless traffic channel.

A still further embodiment of the invention encompasses an article. The article includes a computer-readable signal-bearing medium. The article includes means in the medium for dividing a traffic portion of a message into traffic subportions that comprise first and second traffic subportions. The article includes means in the medium for inserting respective portions of first and second communications into the first and second traffic subportions, respectively. The article includes means in the medium for inserting identifier information into an identifier portion of the message. The identifier portion comprises a description of the portions of the first and second communications. The article includes means in the medium for communicating the message over a wireless traffic channel.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises one or more communication components, one or more communication media, and one or more networks.

FIGS. 2A-2B represent exemplary logic that serves to allow employment of a same traffic block of a wireless traffic channel to support multiple contemporaneous and/or simultaneous communications to and/or from a communication component of the apparatus of FIG. 1.

FIG. 3 represents a call flow that serves to illustrate a first progression through state changes for a communication component of the apparatus of FIG. 1

FIG. 4 represents a call flow that serves to illustrate a second progression through state changes for a communication component of the apparatus of FIG. 1

FIG. 5 represents a call flow that serves to illustrate a third progression through state changes for a communication component of the apparatus of FIG. 1

FIG. 6 represents a call flow that serves to illustrate a fourth progression through state changes for a communication component of the apparatus of FIG. 1

FIG. 7 represents a first example of a traffic block of a wireless traffic channel employable by a communication component of the apparatus of FIG. 1

FIG. 8 represents a second example of a traffic block of a wireless traffic channel employable by a communication component of the apparatus of FIG. 1

FIG. 9 represents a third example of a traffic block of a wireless traffic channel employable by a communication component of the apparatus of FIG. 1

FIG. 10 represents a fourth example of a traffic block of a wireless traffic channel employable by a communication component of the apparatus of FIG. 1

FIG. 11 represents a fifth example of a traffic block of a wireless traffic channel employable by a communication component of the apparatus of FIG. 1

FIG. 12 represents a sixth example of a traffic block of a wireless traffic channel employable by a communication component of the apparatus of FIG. 1

FIG. 13 represents a seventh example of a traffic block of a wireless traffic channel employable by a communication component of the apparatus of FIG. 1

### DETAILED DESCRIPTION

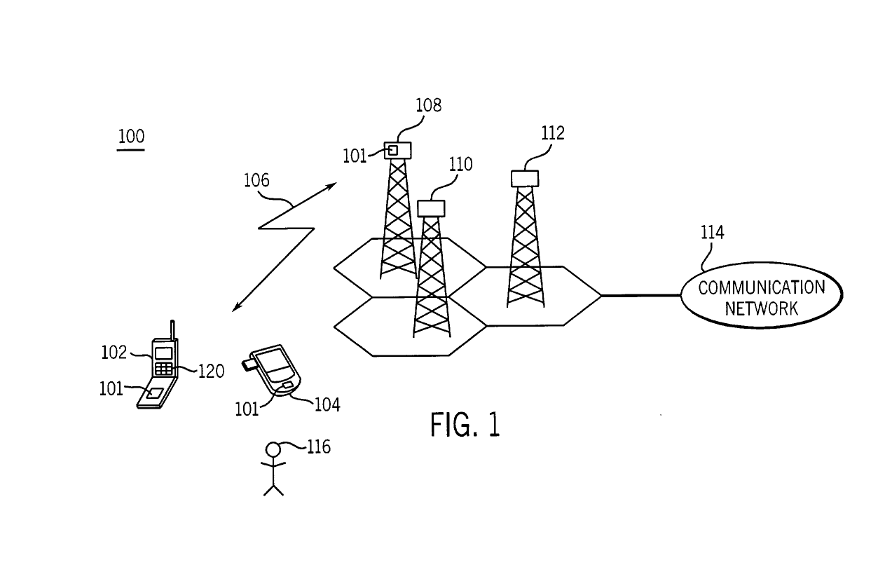

Turning to FIG. 1, an apparatus 100 in one example comprises a plurality of components such as computer software and/or hardware components. A number of such components can be combined or divided in the apparatus 100.

In one example, the apparatus 100 employs at least one computer-readable signal-bearing medium. One example of a computer-readable signal-bearing medium for the apparatus 100 comprises an instance of a recordable data storage medium 101 such as one or more of a magnetic, electrical, optical, biological, and atomic data storage medium. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

The apparatus 100 in one example comprises one or more communication components, one or more communication media, and one or more networks. The communication components of the apparatus 100 in one example comprise wireless communication devices 102 and 104 and base stations 108, 110, and 112. The wireless communication devices 102 and 104 in one example comprise one or more of handheld devices, mobile handsets, cellular phones, mobile computers, and personal digital assistants (“PDAs”). In one example, the wireless communication devices 102 and 104 are operable by one or more users 116. The user 116 in one example comprises a human operator. The base stations 108, 110, and 112 in one example comprise receiver and/or transmitter stations and/or satellites.

The communication media of the apparatus 100 in one example comprise one or more wireless radio frequency carriers 106. For example, the wireless radio frequency carrier 106 comprises an air interface. The wireless radio frequency carrier 106 in one example comprises one or more wireless control and/or traffic channels. The one or more wireless traffic channels in one example comprise one or more forward traffic channels and one or more reverse traffic channels. The one or more wireless control channels in one example comprise one or more forward control channels and one or more reverse control channels.

The base station 108 in one example employs the forward traffic and/or control channels for communication with the wireless communication device 102. The wireless communication device 102 in one example employs the reverse traffic and/or control channels for communication with the base station 108. The base stations 108, 110, and 112 in one example serve to support the one or more wireless traffic and/or control channels for communication with and/or among the wireless communication devices 102 and 104. For example, each of the base stations 108, 110, and 112 employs a distinguishable instance of the wireless radio frequency carrier 106, as will be appreciated by those skilled in the art.

The wireless communication devices 102 and 104 and the base stations 108, 110, and 112 in one example employ code division multiple access (“CDMA”) technology for communication over the wireless traffic channels. For example, the wireless communication devices 102 and 104 and the base stations 108, 1 10, and 112 employ channel coding that is specific (e.g., unique) to the particular wireless radio frequency carrier 106 employed for the wireless traffic channel. In another example, the wireless communication devices 102 and 104 and the base stations 108, 110, and 112 employ time division multiple access (“TDMA”) technology for communication over the wireless traffic channels, as described herein.

The one or more networks of the apparatus 100 in one example comprise one or more communication networks 114. The communication network 114 in one example serves to route certain voice, data, and signaling messages and support wireless communication among the wireless communication devices 102 and 104 and the base stations 108, 110, and 112. For example, the communication network 114 comprises one or more wireless networks and zero or more wireline networks.

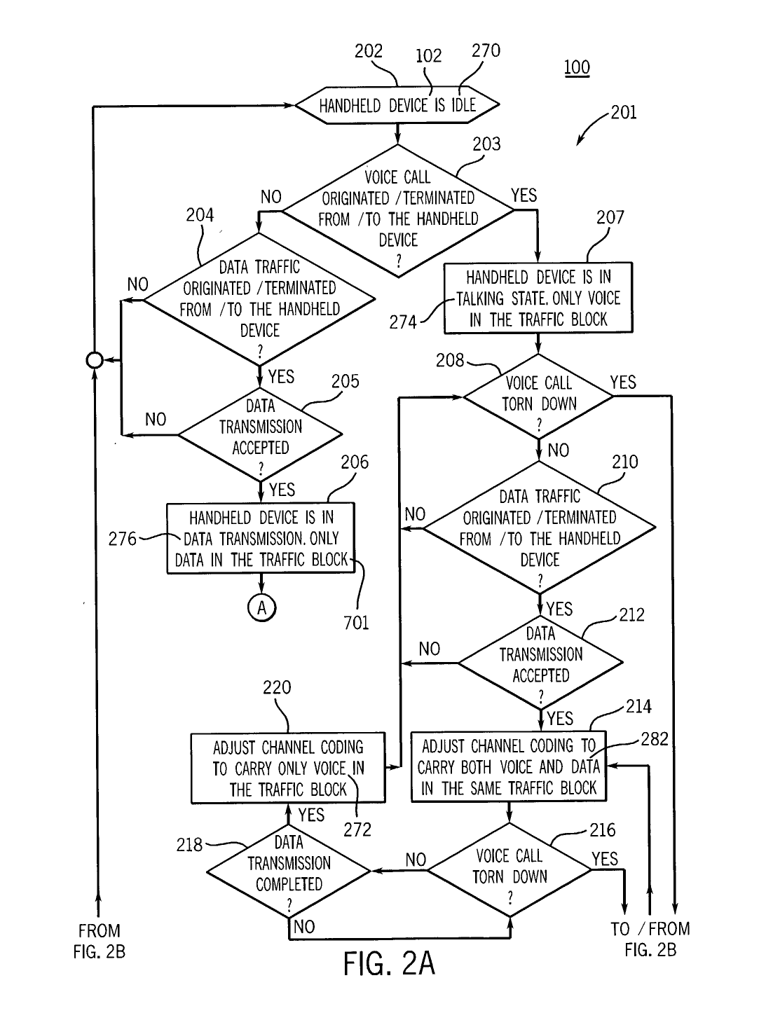

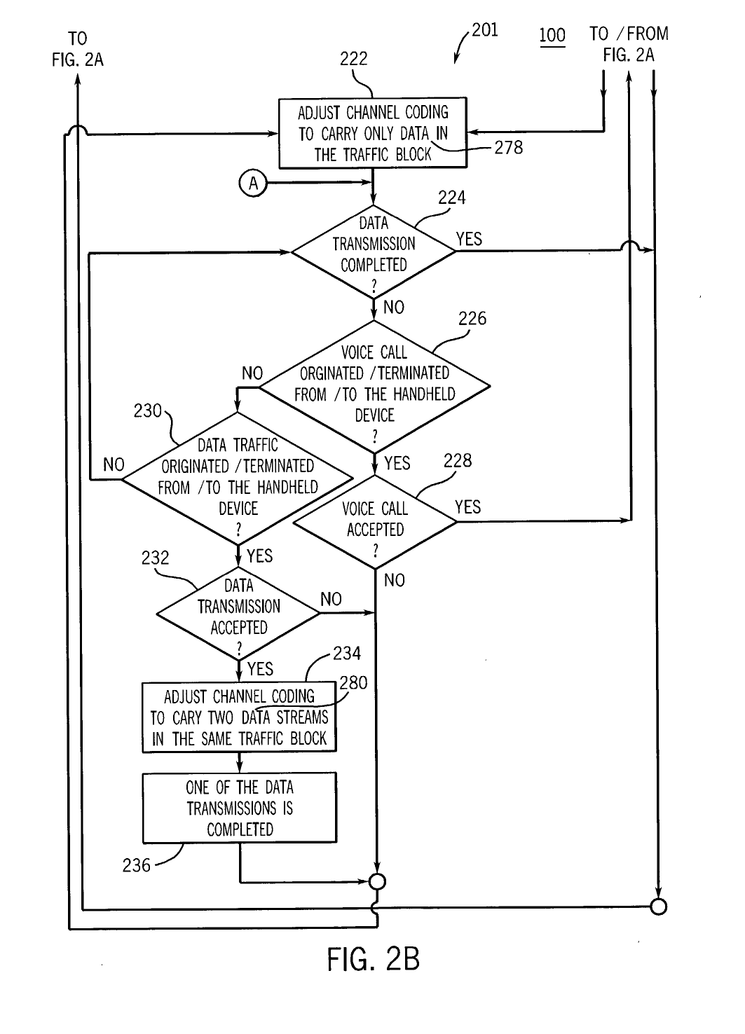

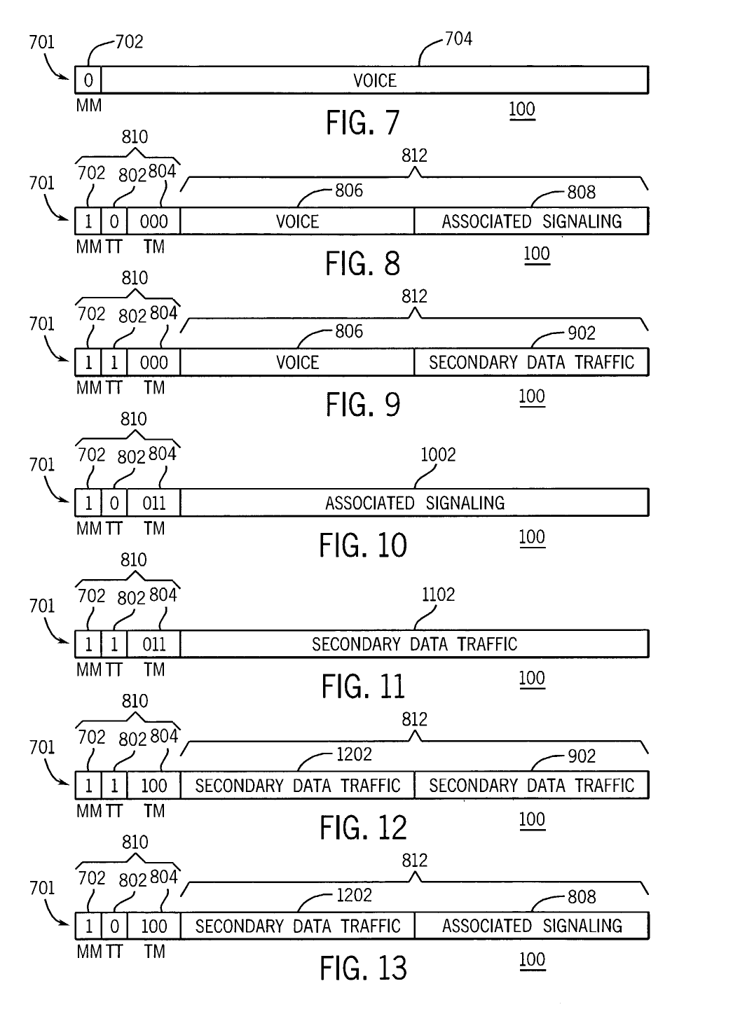

Turning to FIGS. 2A-2B, exemplary logic 201 serves to allow the apparatus 100 to employ a same traffic block 701 (FIG. 7) of a wireless traffic channel to support multiple contemporaneous and/or simultaneous communications to and/or from the wireless communication device 102, as described herein. The apparatus 100 can support and/or accommodate one or more different and/or separate communications in the same wireless traffic channel. The logic 201 employs one or more steps, for example, STEPS 202, 203, 204, 205, 206, 207, 208, 210, 212, 214, 216, 218, 220, 222, 224, 226, 228, 230, 232, 234, and 236.

The logic 201 in one example serves to allow the apparatus 100 to support up to two contemporaneous and/or simultaneous communications in the same wireless traffic channel. The exemplary description herein is easily extendible to allow the apparatus 100 to support any number of contemporaneous and/or simultaneous communications. For example, one or more implementations of the apparatus 100 support three, four, or more contemporaneous and/or simultaneous communications in the same wireless traffic channel, as will be appreciated by those skilled in the art.

The communications in one example comprise signaling information, data, and voice. The signaling information in one example comprises setup and/or control messages between the base station 108 and the wireless communication device 102. The data in one example comprises one or more of text messages, data files, digital images, software components, electronic mail, and facsimile transmissions. The voice in one example comprises an audio communication.

In one example, the communication is originated from the wireless communication device 102 and terminates at the base station 108. A communication originated from the wireless communication device 102 in one example comprises an upload or uplink carried over one of the reverse traffic channels. The information conveyed in the communication can be further communicated by the base station 108 to another component of the apparatus 100. In another example, the communication is originated from the base station 108 and terminates at the wireless communication device 102. A communication originated from the base station 108 in one example comprises a download or downlink carried over one of the forward traffic channels. The information conveyed in the communication can be further communicated by the communication device 102 to another component of the apparatus 100, as will be appreciated by those skilled in the art.

In the logic 201, the wireless communication device 102 passes through a number of states in traversing the steps. At STEP 202, the wireless communication device 102 occupies Idle state 270. At STEPS 220 and 207, the wireless communication device 102 occupies Voice states 272 and 274, respectively. At STEPS 206 and 222, the wireless communication device 102 occupies Single Data states 276 and 278, respectively. At STEP 234, the wireless communication device 102 occupies Multiple Data state 280. At STEP 214, the wireless communication device 102 occupies Voice+Data state 282, as described herein.

The wireless communications device 102 begins in the Idle state 270 at STEP 202 and then proceeds to STEP 203. If a voice call does not originate or terminate at the wireless communication device 102, then STEP 203 proceeds to STEP 204. If a data transmission originates or terminates at the wireless communication device 102, then STEP 204 proceeds to STEP 205. One example of a data transmission originating at the wireless communication device 102 comprises an uploading of a data message from the wireless communication device 102 to the base station 108. One example of a data transmission terminating at the wireless communication device 102 comprises a downloading of a data message from the base station 108 to the wireless communication device 102.

If the data transmission is accepted by the wireless communication device 102 and the base station 108, then STEP 205 proceeds to STEP 206. The wireless communication device 102 occupies the Single Data state 276 at STEP 206 and then proceeds to STEP 224. The data transmission is checked for completeness at STEP 224.

Should a voice transmission originate or terminate at the wireless communication device 102 at STEP 203, then STEP 203 proceeds to STEP 207. The wireless communication device 102 proceeds to the Voice state 274 at STEP 207 and then proceeds to STEP 208. The voice transmission is checked for completeness at STEP 208. If the voice transmission has completed at STEP 208, then the wireless communication device 102 proceeds to the Idle state 270 at STEP 202.

Should the voice transmission have not completed at STEP 208, then STEP 208 proceeds to STEP 210. If a data transmission originates or terminates at the wireless communication device 102, then STEP 210 proceeds to STEP 212. If the data transmission is accepted by the wireless communication device 102 and the base station 108, then STEP 212 proceeds to STEP 214. The wireless communication device 102 proceeds to the Voice+Data state 282 at STEP 214, and then proceeds to STEP 216. If the voice transmission has not completed, then STEP 216 proceeds to STEP 218. If the data transmission has completed at STEP 218, then the wireless communication device 102 proceeds to the Voice state 272 at STEP 220, and then proceeds to STEP 208. The voice transmission is again checked for completion at STEP 208.

Should the voice transmission have completed at STEP 216, then STEP 216 proceeds to STEP 222. The wireless communication device 102 proceeds to the Single Data state 278 at STEP 222, and then proceeds to STEP 224. If the data transmission has completed at STEP 224, then the wireless communication device 102 proceeds to the Idle state 270 at STEP 202.

Should the data transmission have not completed at STEP 224, then STEP 224 proceeds to STEP 226. If a voice transmission originates or terminates at the wireless communication device 102 at STEP 226, then STEP 226 proceeds to STEP 228. If the voice transmission is accepted by the wireless communication device 102 and the base station 108, then STEP 228 proceeds to STEP 214. The wireless communication device 102 proceeds to the Voice+Data state 282 at STEP 214, and then proceeds to STEP 216.

Should a voice transmission have not originated or terminated at the wireless communication device 102 at STEP 226, then STEP 226 proceeds to STEP 230. If a data transmission originates or terminates at the wireless communication device 102 at STEP 230, then STEP 230 proceeds to STEP 232. If the data transmission is accepted by the wireless communication device 102 and the base station 108, then STEP 232 proceeds to STEP 234. The wireless communication device 102 proceeds to the Multiple Data state 280 at STEP 234, and then proceeds to STEP 236. The wireless communication device 102 remains in the Multiple Data state 280 at STEP 236 until one of the data transmissions has completed. When one of the data transmissions is completed, the wireless communication device 102 proceeds to the Single Data state 278 at STEP 222. When the remaining data transmission has completed at STEP 224, then the wireless communication device 102 proceeds to the Idle state 270 at STEP 202.

Returning to FIG. 1, the wireless communication device 102 in one example allows the user 116 to choose whether to accept, reject, or postpone receipt of an incoming data communication. The base station 108 sends a signaling message to the wireless communication device 102. The signaling messages may be sent in a traffic channel or a control channel, for example, depending on the state of the wireless communication device 102. If the wireless communication device 102 and the base station 108 have a traffic channel set up for communication, then the traffic channel in one example is used to deliver the signaling messages.

When the wireless communication device 102 receives the signaling message, the wireless communication device 102 sends a notification to present to the user 116 an opportunity to accept, reject, or postpone receipt of the incoming data communication. The notification in one example comprises one or more messages, rings, tones, or screen display items. The wireless communication device 102 in one example comprises one or more signal interface components 120. The signal interface component 120 in one example comprises one or more of indicators, buttons, icons, and touch screen displays. Exemplary indicators of the signal interface component 120 comprise DOWNLOAD, REJECT, LATER, and UPLOAD. The DOWNLOAD indicator is employable to accept the incoming data communication. The REJECT indicator is employable to reject the incoming data communication. The LATER indicator is employable to suspend the incoming data communication. The UPLOAD indicator is employable to request execution of an outgoing data communication.

The user 116 in one example employs the signal interface component 120 to send a signaling message to the base station 108 that serves to indicate acceptance, rejection, or request for postponement of receipt of the incoming data communication. Upon receipt of a signaling message that results from operation of the DOWNLOAD indicator, the base station 108 begins transmission of the data communication. Upon receipt of a signaling message that results from operation of the REJECT indicator, the base station 108 discards the data communication. Upon receipt of a signaling message that results from operation of the LATER indicator, the base station 108 stores the data communication and periodically attempts to resend the data communication to the wireless communication device 102.

In a further example, the wireless communication device 102 in one example allows the user 116 to choose whether to initiate an outgoing data communication. The user 116 activates the UPLOAD indicator to send a signaling message to the base station 108 that serves to request transmission of the data communication, as will be appreciated by those skilled in the art.

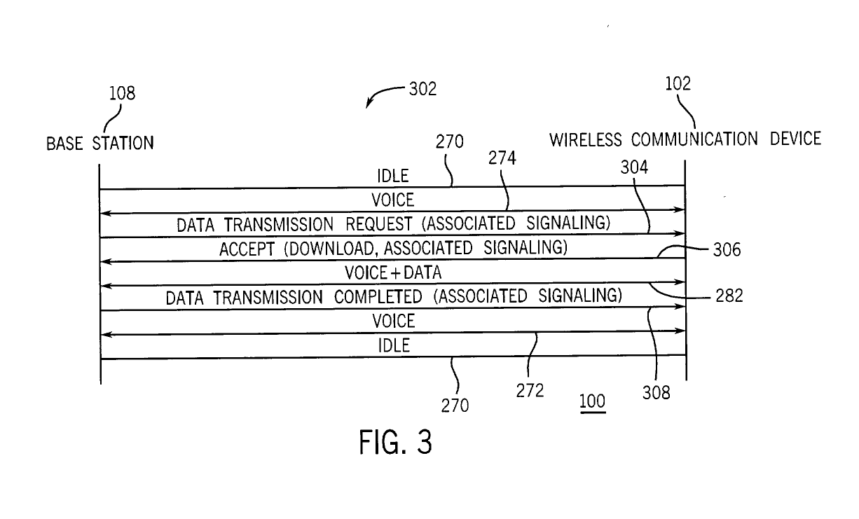

For explanatory purposes, now referring to FIGS. 3-6, exemplary call flows 302, 402, 502, and 602 serve to represent progression of the apparatus 100 through a number of illustrative state changes. As presented in the following discussion of the call flows 302, 402, 502, and 602, referring to FIGS. 7-13, the wireless traffic channels employed by the apparatus 100 comprise one or more traffic blocks 701. The one or more traffic blocks 701 serve to carry zero, one, or a plurality of communications. The one or more traffic blocks 701 comprise one or more of identifier portions 702 and 802 and one or more of traffic portions 704, 812, 1002, and 1102. The traffic portion 812 comprises one or more of traffic subportions 806, 808, 902, and 1202.

The apparatus 100 in one example employs code division multiple access technology for communication in the traffic blocks 701. For example, the traffic block 701 comprises a group of bits. In another example, the apparatus 100 employs time division multiple access technology for communication in the traffic blocks 701. In a further example, a group of bits that comprises the traffic block 701 can be transmitted in a certain time allocation.

With code division multiple access technology, the apparatus 100 in one example supports multiple communications by dividing the traffic blocks 701. For example, referring to FIG. 9, the wireless communication device 102 transmits voice and data traffic in the same traffic block 701. In another example, referring to FIGS. 7 and 11, the wireless communication device 102 transmits multiple communications in multiple (e.g., staggered) sets of traffic blocks 701. For example, the wireless communication device 102 transmits voice and data traffic in the same code division multiple access traffic channel by alternating transmission of portions of a first communication in instances of the traffic block 701 of FIG. 7 with transmission of portions of a second communication in instances of the traffic block 701 of FIG. 11.

Referring to FIG. 3, the call flow 302 serves to illustrate a progression of the wireless communication device 102 through the following state changes: the Idle state 270 to the Voice state 274 to the Voice+Data state 282 to the Voice state 272 to the Idle state 270. Upon occupation of the Idle state 270 of the wireless communication device 102, the base station 108 and the wireless communication device 102 have set up a forward traffic channel and a reverse traffic channel. The wireless communication device 102 proceeds to the Voice state 274 after receiving and/or sending a voice transmission.

During the Voice state 274, referring to FIG. 7, the traffic block 701 of the forward and reverse traffic channels carry the voice transmission in the traffic portion 704. Referring to FIG. 8, while the voice transmission remains active in the traffic subportion 806, the base station 108 sends a data transmission request 304 to the wireless communication device 102. The base station 108 employs associated signaling in the traffic subportion 808 in the forward traffic channel to notify the wireless communication device 102 of the waiting data transmission. For example, the associated signaling comprises a message such as “alert with information.”

The user 116 of the wireless communication device 102 is presented with an opportunity to accept, reject, or postpone receipt of the data transmission. In one example, the user 116 sends to the base station 108 an acceptance 306 of the data transmission. The user 116 employs associated signaling in the traffic subportion 808 in the reverse traffic channel to notify the base station 108 of the acceptance. For example, the user 116 effects the acceptance through activation of the DOWNLOAD indicator on the wireless communication device 102. The wireless communication device 102 proceeds to the Voice+Data state 282. Referring to FIG. 9, the traffic block 701 of the forward traffic channel is adjusted to carry voice and data in traffic subportions 806 and 902, respectively. Referring to FIG. 7, the reverse traffic channel is adjusted to carry voice only in the traffic portion 704.

If the data transmission is completed while the voice transmission is still active, the base station 108 sends an indication 308 of completion in the associated signaling of the traffic subportion 808 to the wireless communication device 102 to indicate the completion of the data transmission. The wireless communication device 102 proceeds to the Voice state 272. Upon receipt by the wireless communication device 102 of the associated signaling in the traffic subportion 808, the traffic block 701 of the forward traffic channel is adjusted to carry voice only in the traffic portion 704. The reverse traffic channel carries voice only in the traffic portion 704. Upon completion of the voice transmission, the wireless traffic channels are properly closed and/or held idle with the wireless communication device 102 proceeding to the Idle state 270.

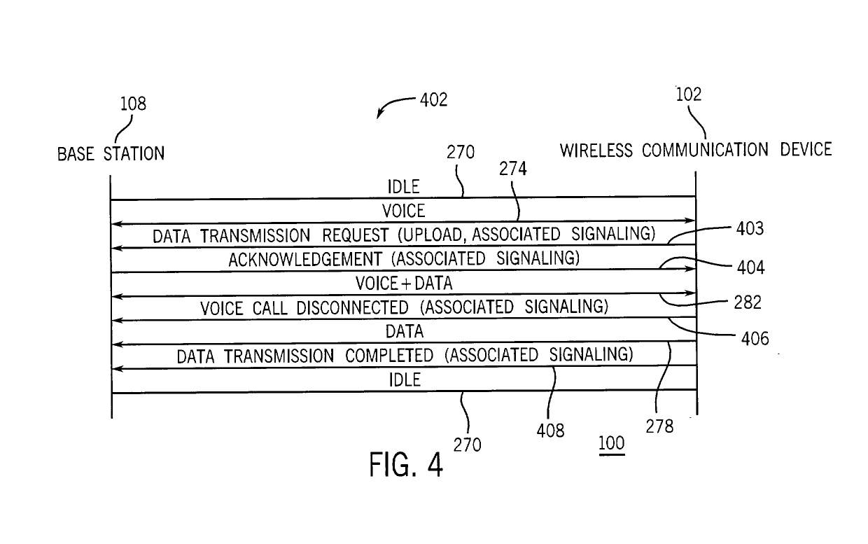

Referring to FIG. 4, the call flow 402 serves to illustrate a progression of the wireless communication device 102 through the following state changes: the Idle state 270 to the Voice state 274 to the Voice+Data state 282 to the Single Data state 278 to the Idle state 270. FIG. 4 illustrates the state changes and the message flow for this particular scenario. The wireless communication device 102 begins in the Idle state 270. The wireless communication device 102 proceeds to the Voice state 274 after receiving and/or sending a voice transmission. Referring to FIG. 7, the traffic block 701 in the forward and reverse traffic channels carry the voice transmission in the traffic portion 704.

While the voice transmission is still active, the wireless communication device 102 initiates a data transmission request 403. Referring to FIG. 8, the wireless communication device 102 sends the data transmission request 403 to the base station 108 as the associated signaling in the traffic subportion 808. For example, the associated signaling comprises a message such as “data burst.” In one example, the user 116 effects the request through activation of the UPLOAD indicator on the wireless communication device 102. The base station 108 accepts the data transmission with an acknowledgement 404 as the associated signaling in the traffic subportion 808 of the forward traffic channel. The wireless communication device 102 proceeds to the Voice+Data state 282. Referring to FIG. 9, the traffic block 701 of the reverse traffic channel is adjusted to carry voice and data in the traffic subportions 806 and 902, respectively. Referring to FIG. 7, the forward traffic channel is adjusted to carry voice only in the traffic portion 704.

If the voice transmission is completed while the data transmission is still active, referring to FIG. 13, the wireless communication device 102 sends a disconnection message 406 as the associated signaling in the traffic subportion 808 to indicate the completion of the voice transmission. For example, the associated signaling comprises a message such as “release.” Upon completion of the voice transmission, the wireless communication device 102 proceeds to the Single Data state 278. The traffic block 701 of the reverse traffic channel is then adjusted to carry data only in the traffic portion 1102. The forward traffic channel is idle. Upon completion of the data transmission, the wireless communication device 102 sends a notification 408 to the base station 108 as the associated signaling in the traffic portion 1002. The wireless communication device 102 proceeds to the Idle state 270.

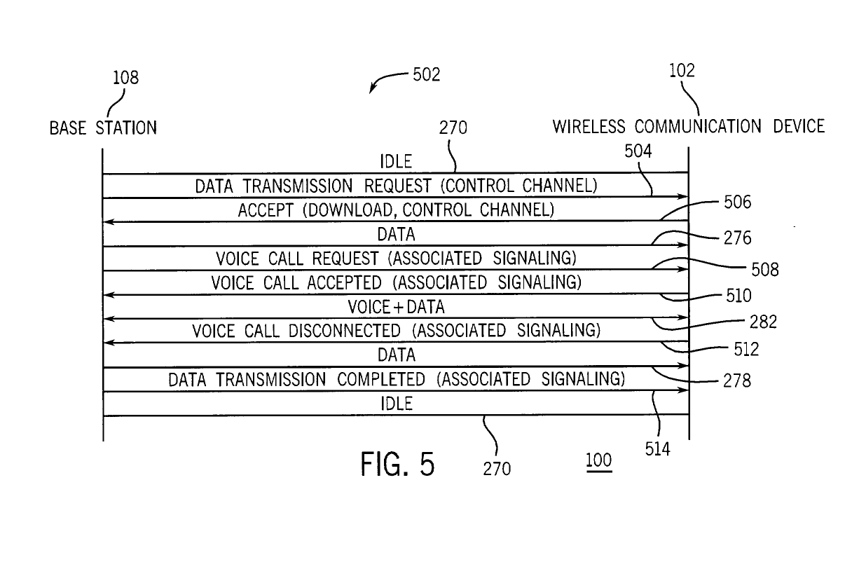

Referring to FIG. 5, the call flow 502 serves to illustrate a progression of the wireless communication device 102 through the following state changes: the Idle state 270 to the Single Data state 276 to the Voice+Data state 282 to the Single Data state 278 to the Idle state 270. The wireless communication device 102 begins in the Idle state 270. In one example, the forward and reverse wireless traffic channels have not yet been set up between the base station 108 and the wireless communication device 102. The base station 108 sends a data transmission request 504 to the wireless communication device 102 in a control channel, for example, as a downlink. The data transmission request 504 in one example comprises a message such as “feature notification.” The user 116 of the wireless communication device 102 sends an acceptance 506 to the base station 108 as a response in the control channel, for example, as an uplink. The control channels are thus employed to set up the forward and reverse wireless traffic channels. The wireless communication device 102 proceeds to the Single Data state 276.

Upon occurrence of the Single Data state 276, referring to FIG. 11, the traffic block 10 701 of the forward traffic channel carries data only in the traffic portion 1102. The reverse traffic channel is idle. While the data transmission is still active, the base station 108 sends a voice transmission request 508 to the wireless communication device 102. Referring to FIG. 13, the base station 108 sends the associated signaling in the traffic subportion 808 to notify the user 116 of the wireless communication device 102 of the presence of the waiting voice transmission. The user 116 is presented with an opportunity to accept or reject the voice transmission. In one example, referring to FIG. 10, the user 116 accepts the voice transmission by sending an acceptance 510 to the base station 108 as the associated signaling in the traffic portion 1002 of the reverse traffic channel.

Upon acceptance of the voice transmission by the wireless communication device 102, the wireless communication device 102 proceeds to the Voice+Data state 282. Referring to FIG. 9, the traffic block 701 of the forward traffic channel is adjusted to carry both voice and data in the traffic subportions 806 and 902, respectively. Referring to FIG. 7, the traffic block 701 of the reverse traffic channel is adjusted to carry voice only in the traffic portion 704. If the voice transmission is completed while the data transmission is still active, referring to FIG. 10, the wireless communication device 102 sends a disconnection indication 512 to the base station 108 in the associated signaling in the traffic portion 1002 to indicate in the reverse traffic channel the completion of the voice transmission.

Upon completion of the voice transmission, the wireless communication device 102 proceeds to the Single Data state 278. Referring to FIG. 11, the traffic block 701 of the forward traffic channel is adjusted to carry only the data transmission in the traffic portion 1102. The reverse traffic channel is idle. Upon completion of the data transmission, referring to FIG. 10, the base station 108 sends a completion indication 514 as the associated signaling of the traffic portion 1002 in the forward traffic channel to indicate the completion of the data transmission. The wireless communication device 102 then proceeds to the Idle state 270.

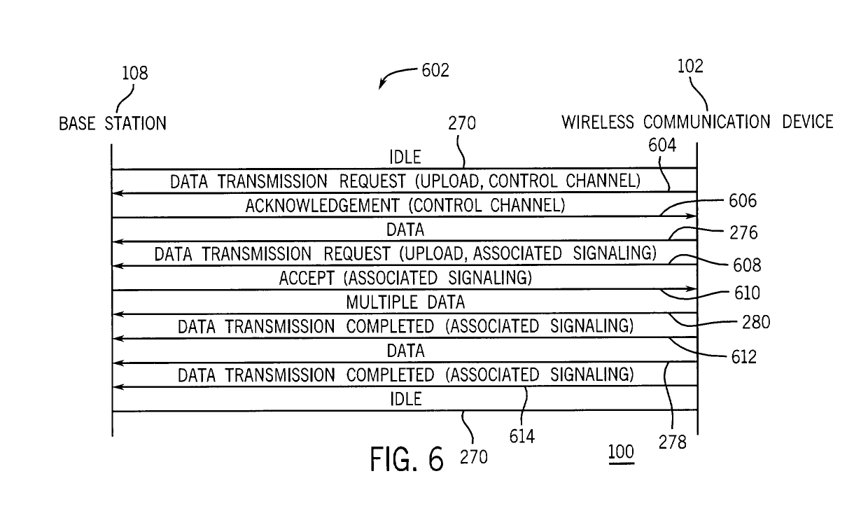

Referring to FIG. 6, the call flow 602 serves to illustrate a progression of the wireless communication device 102 through the following state changes: the Idle state 270 to the Single Data state 276 to the Multiple Data state 280 to the Single Data state 278 to the Idle state 270. The wireless communication device 102 begins in the Idle state 270. The wireless communications device 102 sends a data transmission request 604 to the base station 108 in a control channel, for example, an uplink. The base station 108 sends an acknowledgement 606 to the wireless communication device 102 in the control channel, for example, a downlink. The control channels are thus employed to set up the forward and reverse wireless traffic channels. The wireless communication device 102 proceeds to the Single Data state 276.

Referring to FIG. 11, the traffic block 701 of the reverse traffic channel carries data in the traffic portion 1102. The forward traffic channel is idle. While the first data transmission is still active, the wireless communication device 102 initiates a second data transmission. Referring to FIG. 13, the wireless communication device 102 sends a request 608 for the second data transmission in the associated signaling of the traffic subportion 808.

Referring to FIG. 10, the base station 108 sends an acceptance 610 of the second data transmission in the associated signaling of the traffic portion 1002 in the forward traffic channel. Upon acceptance of the second data transmission by the base station 108, the wireless communication device 102 proceeds to the Multiple Data state 280. Referring to FIG. 12, the traffic block 701 of the wireless traffic channel is adjusted to carry the first data and the second data in the traffic subportions 1202 and 902, respectively, of the same reverse traffic channel. The forward traffic channel is idle.

When one of the data transmissions has completed and the other data transmission is still active, referring to FIG. 13, the wireless communication device 102 sends a completion lo indication 612 to the base station 108 in the associated signaling in the traffic subportion 808 to indicate the completion of the finished data transmission. The wireless communication device 102 proceeds to the Single Data state 278. Referring to FIG. 11, the traffic block 701 of the reverse traffic channel is adjusted to carry only the data transmission that is still active in the traffic portion 1102. The forward traffic channel is idle.

Upon completion of the second data transmission, referring to FIG. 10, the wireless communication device 102 sends a completion indication 614 in the associated signaling in the traffic portion 1002 of the reverse traffic channel to indicate the completion of the data transmission. The wireless communication device 102 proceeds to the Idle state 270.

The apparatus 100 also supports handovers or handoffs between the base stations 108 and 110 of continuous communications of the wireless communication devices 102 and 104. For example, referring to FIG. 9, the base station 108 supports voice and data in traffic subportions 806 and 902, respectively, of a first wireless traffic channel. In a further example, movement of the wireless communication device 102 from a physical region serviced by the base station 108 to a physical region serviced by the base station 110 results in the base station 110 supporting a continuation of the voice and a continuation of the data in traffic subportions 806 and 902, respectively, of a second wireless traffic channel.

Referring to FIGS. 7-13, the traffic block 701 comprises an identifier portion 702 and/or 810 that serves to describe a corresponding one of the traffic portions 704, 812, 1002, or 1102. For example, the identifier portion 702 or 810 comprises one or more of identifier information, identifier code, a header field, a label, a tone, and communication exchange information. In a further example, the identifier portion 702 or 810 serves to identify the corresponding state of operation of the traffic block 701, for example, Voice state 272 or 274, Single Data state 276 or 278, Multiple Data state 280, or Voice+Data state 282.

The identifier portion 810 serves to label the traffic block 701 of the wireless traffic channel based on the communications transmitted in the traffic block 701. The identifier portion 810 is able to support any of zero, one, or a plurality of communications. Modification and/or expansion of the identifier portion 810 in one example serves to accommodate one or more selected capabilities and/or states for supporting transmission of communications in the same traffic block 701 of the wireless traffic channel.

Referring to FIG. 7, the identifier portion 702 in one example comprises one bit. Referring to FIGS. 8-13, the identifier portion 810 in one example comprises five bits. In a further example, the identifier portion 810 in one example comprises any number of bits, for example, more than five bits. The identifier portion 810 in one example comprises the identifier portion 702, identifier code 802, and identifier code 804. The identifier portion 702 in one example comprises mixed mode information. One implementation of the mixed mode (“MM”) information of the identifier portion 702 is presented below.

| | |
|---|---|
| MM: | Mixed Mode |
| | 0 - Voice |
| | 1 - Voice + Data + Signaling |

The identifier code 802 in one example comprises traffic type (“TT”) information. One implementation of the traffic type information of the identifier code 802 is presented below.

| | |
|---|---|
| TT: | Traffic Type |
| | 0 - Signaling |
| | 1 - Data |

The identifier code 804 in one example comprises traffic mode (“TM”) information. One implementation of the traffic mode information of the identifier code 804 is presented below.

| | |
|---|---|
| TM: | Traffic Mode |
| | 000 - Rate 1/2 Voice + Signaling/Data |
| | 001 - Rate 1/4 Voice + Signaling/Data |
| | 010 - Rate 1/8 Voice + Signaling/Data |
| | 011 - Full Rate Signaling/Data |
| | 100 - Rate 1/2 Data + Signaling/Data |
| | 101 - Rate 1/4 Data + Signaling/Data |
| | 110 - Rate 1/8 Data + Signaling/Data |
| | 111 - Reserved |

The transmission rate of a communication in one example relates directly to the percentage of the traffic block 701 allocated to the communication. For example, the communication at different times comprises different percentages of the traffic blocks 701.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be make without departing from the spirit of the invention and these are therefore considered to be within the scope of the invention as defined in the following claims.

We claim:

1. An apparatus, comprising:
a first communication component that employs one traffic block of one code division multiple access traffic channel to communicate respective portions of first and second communications to a second communication component.

2. The apparatus of claim 1, wherein the portion of the first communication comprises any one of signal information, data, and voice;
wherein the portion of the second communication comprises any one of signal information, data, and voice.

3. The apparatus of claim 1, wherein the first communication component comprises a base station, wherein the second communication component comprises a handheld communication device.

4. The apparatus of claim 3, wherein the one code division multiple access traffic channel comprises a first code division multiple access traffic channel supported by the base station, wherein the respective portions of the first and second communications comprise respective first portions of the first and second communications, wherein the base station comprises a first base station;
wherein a second base station employs one traffic block of a second code division multiple access traffic channel to communicate respective second portions of the first and second communications to the handheld communication device, wherein the second code division multiple access traffic channel is supported by the second base station.

5. The apparatus of claim 1, wherein the first communication component comprises a handheld communication device, wherein the second communication component comprises a base station.

6. The apparatus of claim 5, wherein the one code division multiple access traffic channel comprises a first code division multiple access traffic channel supported by the base station, wherein the respective portions of the first and second communications comprise respective first portions of the first and second communications, wherein the base station comprises a first base station;
wherein the handheld communication device employs one traffic block of a second code division multiple access traffic channel to communicate respective second portions of the first and second communications to a second base station, wherein the second code division multiple access traffic channel is supported by the second base station.

7. The apparatus of claim 1, wherein the first communication component inserts identifier information into an identifier portion of the one traffic block, wherein the first communication component inserts the respective portions of the first and second communications into a traffic portion of the one traffic block;
wherein the identifier portion comprises a description of the traffic portion.

8. The apparatus of claim 7, wherein the one traffic block comprises a first traffic block of the one code division multiple access traffic channel, wherein the identifier information comprises first identifier information, wherein the traffic portion comprises a first traffic portion;
wherein at a first time the first communication component:
inserts the first identifier information into the identifier portion of the first traffic block; and
inserts the respective portions of the first and second communications into the traffic portion of the first traffic block;
wherein the first identifier portion comprises the description of the traffic portion of the first traffic block;
wherein at a second time the first communication component:
inserts second identifier information into an identifier portion of a second traffic block of the one code division multiple access traffic channel; and
inserts a portion of a third communication into a traffic portion of the second traffic block;
wherein the second identifier portion comprises a description of the traffic portion of the second traffic block;
wherein at the second time the first communication component employs the second traffic block to communicate the portion of the third communication to the second communication component.

9. The apparatus of claim 1, wherein the one traffic block comprises a first traffic block of the one code division multiple access traffic channel, wherein at a first time the first communication component employs the first traffic block to communicate the respective portions of the first and second communications to the second communication component, wherein the respective portions of the first and second communications comprise respective first portions of the first and second communications;
wherein at a second time the first communication component employs a second traffic block of the one code division multiple access traffic channel to communicate to the second communication component any one or more of a second portion of the first communication, a second portion of the second communication, and a portion of a third communication.

10. The apparatus of claim 1, wherein the first communication component comprises a base station, wherein the second communication component comprises a handheld communication device, wherein the one traffic block comprises a first traffic block of the one code division multiple access traffic channel;
wherein at a first time the base station employs the first traffic block to communicate the respective portions of the first and second communications to the handheld communication device, wherein at a second time the base station employs a portion of a second traffic block of the one code division multiple access traffic channel to present to the handheld communication device an opportunity to receive a portion of a third communication that comprises data;
wherein the handheld communication device comprises a selection interface that allows a user to indicate a selection of any one of acceptance, rejection, or postponement of receipt of the portion of the third communication.

11. The apparatus of claim 10, wherein the one code division multiple access traffic channel comprises a first code division multiple access traffic channel, wherein upon employment of the selection interface by the user to indicate the selection the handheld communication device employs one traffic block of a second code division multiple access traffic channel to communicate an indication of the selection to the base station;
wherein upon receipt of the indication of the selection the base station any corresponding one of transmits the portion of the third communication, withholds transmission of the portion of the third communication, and stores the portion of the third communication based on the selection by the user of the respective any one of the acceptance, the rejection, and the postponement of receipt of the portion of the third communication.

12. The apparatus of claim 1, wherein the first communication component comprises a handheld communication device, wherein the second communication component comprises a base station, wherein the one traffic block comprises a first traffic block of the one code division multiple access traffic channel;
wherein at a first time the handheld communication device employs the first traffic block to communicate the respective portions of the first and second communications to the base station, wherein at a second time the handheld communication device employs a portion of a second traffic block of the one code division multiple access traffic channel to present to the base station an opportunity to receive a portion of a third communication that comprises data;
wherein the base station is able to indicate a selection of any one of acceptance, rejection, or postponement of receipt of the portion of the third communication.

13. The apparatus of claim 12, wherein the one code division multiple access traffic channel comprises a first code division multiple access traffic channel, wherein the base station employs one traffic block of a second code division multiple access traffic channel to communicate an indication of the selection to the handheld communication device;
wherein upon receipt of the indication of the selection the handheld communication device any corresponding one of transmits the portion of the third communication, withholds transmission of the portion of the third communication, and stores the portion of the third communication based on the selection by the base station of the respective any one of the acceptance, the rejection, and the postponement of receipt of the portion of the third communication.

14. The apparatus of claim 1, wherein the one traffic block comprises a first traffic block of the one code division multiple access traffic channel, wherein the respective portions of the first and second communications comprise respective first portions of the first and second communications;
wherein at a first time the first communication component employs respective first and second percentages of the first traffic block to communicate the respective first portions of the first and second communications to the second communication component;
wherein at a second time the first communication component employs respective first and second percentages of a second traffic block of the one code division multiple access traffic channel to communicate respective second portions of the first and second communications to the second communication component;
wherein the respective first percentages of the first and second traffic blocks comprise different percentages;
wherein the respective second percentages of the first and second traffic blocks comprise different percentages.

15. An apparatus, comprising:
a first communication component that communicates with a second communication component:
a first subportion of a first communication in a first traffic block of one code division multiple access traffic channel;
a portion of a second communication in a second traffic block of the one code division multiple access traffic channel; and
a second subportion of the first communication in a third traffic block of the one code division multiple access traffic channel;
wherein the second traffic block is subsequent to the first traffic block, wherein the third traffic block is subsequent to the second traffic block.

16. The apparatus of claim 15, wherein the first, second, and third traffic blocks comprise respective first, second, and third identifier portions;
wherein the first identifier portion comprises a description of the first subportion of the first communication;
wherein the second identifier portion comprises a description of the portion of the second communication;
wherein the third identifier portion comprises a description of the second subportion of the first communication.

17. An apparatus, comprising:
a first communication component that inserts identifier information into an identifier portion of a message to indicate a division of a traffic portion of the message into traffic subportions that comprise first and second traffic subportions;
wherein the first communication component communicates respective portions of first and second communications in the first and second traffic subportions, respectively, over a wireless traffic channel to a second communication component.

18. The apparatus of claim 17, wherein the message comprises a traffic block of a code division multiple access air interface traffic channel.

19. The apparatus of claim 17, wherein the message comprises a timeslot of a time division multiple access air interface traffic channel.

20. A method, comprising the steps of:
dividing a traffic portion of a message into traffic subportions that comprise first and second traffic subportions;
inserting respective portions of first and second communications into the first and second traffic subportions, respectively;
inserting identifier information into an identifier portion of the message, wherein the identifier portion comprises a description of the portions of the first and second communications; and
communicating the message over a wireless traffic channel.

21. An article, comprising:
a computer-readable signal-bearing medium; and
means in the medium for dividing a traffic portion of a message into traffic subportions that comprise first and second traffic subportions;
means in the medium for inserting respective portions of first and second communications into the first and second traffic subportions, respectively;
means in the medium for inserting identifier information into an identifier portion of the message, wherein the identifier portion comprises a description of the portions of the first and second communications; and
means in the medium for communicating the message over a wireless traffic channel.
